(19) United States
(12) Patent Application Publication
(10) Pub. No.: US 2015/0259544 A1
(43) Pub. Date: Sep. 17, 2015

(54) PEELABLE FLEXIBLE COATINGS, COMPOSITIONS AND METHODS THEREOF

(71) Applicant: 3M INNOVATIVE PROPERTIES COMPANY, Saint Paul,, MN (US)

(72) Inventors: Doo-Hyun Lee, Sydney (AU); Farhad Fattahi, Sydney (AU); Kui Chen-Ho, Woodbury, MN (US); Syud M. Ahmed, Minneapolis, MN (US); Kusum Gosain, Woodbury, MN (US); Feng Bai, Woodbury, MN (US)

(21) Appl. No.: 14/434,033

(22) PCT Filed: Oct. 24, 2013
(86) PCT No.: PCT/US2013/066573

§ 371 Date: Apr. 7, 2015

(30) Foreign Application Priority Data
Oct. 24, 2012 (AU) 2012244167

(51) Int. Cl. C09D 5/20; C09D 175/04

(52) U.S. Cl. CPC C09D 5/20; C09D 175/04

(57) ABSTRACT

A peelable, flexible coating for a surface is provided, comprising a polymer blend that comprises polyurethane as a major component, and at least a polymer P2 having in comparison to polyurethane a higher peel strength to the surface to be coated and a higher percent elongation at break when cured for imparting a flexible and a peelable quality to the coating.

### FIELD OF TECHNOLOGY

This description generally relates to compositions and coatings for surfaces such as floors, walls, furniture and any equipment requiring surface protection.

### BACKGROUND

Various types of protective polymer coatings have been used to protect surfaces from dirt and wear whilst providing additional functions, such as slip resistance, gloss, and color, on a variety of surfaces such flooring, walls, furniture or specialized equipment, for example. For example, floor surfaces made of materials such as vinyl, linoleum, wood, concrete, marble, terrazzo, ceramic, and the like, have been based on permanent polymeric finish coatings. Such coatings, however, require maintenance through the use of cleaners and tools such as buffing or burnishing machines operated by trained technicians. Coatings typically become worn over time, either from frictional wear or exposure to weather elements. When it becomes necessary to entirely remove the floor finish, chemical strippers are required to dissolve the coating for removal. Use of chemical strippers is typically accompanied by undesirable odors. Other types of semi-permanent coatings utilizing epoxy, or silane technologies have been developed, and likewise, these coating systems often require sanding, mechanical abrasion for removal. In addition to the problem of removal, polymeric floor coatings can be slippery when wet.

Polyurethane is conventionally used for coatings because of its hardness, which gives it the ability to protect the coated surface from abrasion. Due to its stiffness and low adhesion strength to surfaces, polyurethane coatings suffer from becoming flaky with age and often acquiring a worn out look from acquired scratches. Conventionally, the stiffness of polyurethanes may be reduced by incorporating plasticizers into the coating to give the coating greater stress tolerance during use and hence less tendency to crack and flake. However, plasticizers can migrate out of the coating, vaporizing to produce chemical odors, which can be undesirable in enclosed spaces. Furthermore, polyurethanes generally exhibit relatively low peel strength i.e., having poor adhesion to surfaces, compared to adhesives such as epoxies due to polyurethane's low adhesion strength to surfaces, it tends to delaminate. As a result, polyurethane coatings typically show easy film breakage and detachment from a coated surface when attempts are made to remove it from the surface. Surface primers have been used to improve adhesion to the surface. However, primer application steps create further downtime, and furthermore, solvents used in primers may induce cracking in polyurethanes. In some instances, a high-strength compatible adhesive layer is used to improve adhesion of the coating to the surface, but resulting in increased costs and downtime.

There is therefore a need for an improved coating that overcomes the aforementioned shortcomings.

### SUMMARY OF INVENTION

In one aspect, there is provided a peelable, flexible coating for a surface, comprising a polymer blend comprising polyurethane as a major component, and at least a polymer P2 having in comparison to polyurethane a higher peel strength to the surface to be coated and a higher percent elongation at break when cured for imparting a flexible and a peelable quality to the coating.

In another aspect, a coating composition for forming a peelable, flexible coating on a surface is provided, comprising an aqueous blend of a first polymer dispersion D1 comprising polyurethane as a major component, and a second polymer dispersion D2 comprising a polymer P2, polymer P2 having higher peel strength to the surface to be coated and higher percent elongation at break when cured in comparison to polyurethane.

In a further aspect, a method of forming a peelable, flexible coating on a surface is provided, comprising the steps of providing a coating composition comprising an aqueous blend of a first polymer dispersion D1 comprising polyurethane as a major component, and a second polymer dispersion D2 comprising a polymer P2 having in comparison to polyurethane a higher peel strength to the surface to be coated and a higher percent elongation at break when cured, and applying the coating composition over the surface, and curing the coating composition at ambient conditions.

These and other aspects of the invention are described in the detailed description below. In no event should the above summary be construed as a limitation on the claimed subject matter which is defined solely by the claims as set forth herein

### BRIEF DESCRIPTION OF THE DRAWINGS

Throughout the specification, reference is made to the appended drawings, where like reference numerals designate like elements, wherein:

FIG. 1 is a sectional view of a coating applied to a surface with particles of a uniform average size.

FIG. 2A is a sectional view of a coating applied to a surface with particles protruding above the coating surface.

FIG. 2B is a sectional view of a coating applied to a surface with particles of different sizes.

FIG. 3 shows a photograph of a partially peeled coating.

FIG. 4 shows a photograph of an uncoated vinyl tile surface.

FIG. 5 shows a photograph of a micron-sized polypropylene particle coated vinyl tile surface.

FIG. 6 shows another photograph of a micron-sized polypropylene particle coated vinyl tile surface.

FIGS. 7 and 8 show bar charts comparing the gloss values and slip resistance of coatings.

FIG. 9 shows the variation of slip resistance under wet conditions.

The figures are not necessarily drawn to scale. However, it will be understood that the use of a numeral to refer to a component in a given figure is not intended to limit the component in another figure labeled with the same number.

### DETAILED DESCRIPTION

Various aspects of the invention as described herein provide for coatings that are flexible and peelable. Polyurethane-based coatings have been presently developed to overcome its shortcomings of poor adhesion and stiffness. Without wishing to be bound by theory, the inventors have found that by blending polyurethane with another polymer having in comparison to polyurethane properties of higher peel strength and higher percent elongation at break when cured an excellent peelable, flexible coating material that is adhesive yet peelable, and sufficiently flexible without cracking or flaking can be achieved, hence facilitating ease of removal. These coatings provide a means to protect surfaces from conventional wear and tear caused by direct contact, while advantageously enabling users to remove the coatings easily and inexpensively once the coatings are worn out, without the need for conventional chemical strippers or mechanical grinders or sanders. Furthermore, in various embodiments, the coating is a binder for particulate materials that serve various functions, such as slip-resistance under wet/damp conditions while maintaining its high gloss properties. Auxiliary properties such as anti-microbial properties, desiccating properties, etc. can also be achieved through the addition of suitable particulate materials.

The present specification is not limited to the specific examples or data set forth herein. The compositions, coatings and methods disclosed herein are capable of being made, practiced, used, carried out and/or formed in various ways expected of a skilled person in the field once an understanding of the invention is acquired. Numerical indicators, such as first, second, and third, as used in the description and the claims to refer to various structures or method steps, are not meant to be construed to indicate any specific structures or steps, or any particular order or configuration to such structures or steps. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification, and no structures shown in the drawings, should be construed as indicating that any non-claimed element is essential to the practice of the invention. The use herein of the terms “including” “comprising” or “having” and permutations thereof, is meant to encompass the features defined thereafter and equivalents thereof, as well as additional items.

Recitation of ranges of values herein are intended to refer individually to each separate value falling within the range, unless otherwise indicated herein, and each separate value is incorporated into the specification as if it were individually recited herein. For example, if a compositional range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this disclosure. Use of the word “about” to describe a particular recited amount or range of amounts is meant to indicate that values very near to the recited amount are included in that amount, such as values that could or naturally would be accounted for due to manufacturing tolerances, instrument and human error in forming measurements, and the like.

Unless otherwise stated, reference to any document herein does not constitute an admission that any of these documents forms part of the common general knowledge in the art. Any discussion of the references states what their authors assert, and the applicant reserves the right to challenge the accuracy and pertinency of any of the documents cited herein. All references cited herein are fully incorporated by reference, unless explicitly indicated otherwise.

In one aspect, the present disclosure provides a peelable flexible coating that comprises a polymer blend comprising polyurethane as a major component, and a polymer P2 having in comparison to polyurethane a higher peel strength to the surface to be coated as well as higher percent elongation at break when cured.

In this context, the term ‘blend’ refers to any form of polymer blend, including immiscible polymer blends (or heterogeneous polymer blends) having two glass transition temperatures, compatible polymer blends exhibiting macroscopically uniform physical properties due to sufficiently strong interactions between the component polymers, and miscible polymer blends (homogeneous polymer blend) observing a single-phase structure with one glass transition temperature. The term ‘peelable’ refers to the property of being removable by peeling. Peel strength is a measure of adhesive bond strength, and can defined by various measurements, such as the average load required to part two bonded materials per 25 mm separation, or the average load per unit width of bond line required to part two bonded materials where the angle of separation is 180 degrees and separation rate is 6 inches per minute (ASTM D-903). Percent elongation at break of a material refers to its strain at fracture, expressed as a percentage of its initial length. It is a measure of a material's flexibility in terms of how it will deform and strain when weight or force is applied, and may be expressed in terms of percent elongation at break as referenced throughout this application. By definition, flexible materials have a high percent elongation at break, and stiffer materials have a low percent elongation at break. In other words therefore, P2 is selected from a polymer that exhibits greater flexibility and higher adhesive bond strength to the surface to be coated than polyurethane.

In order to achieve a peelable coating, polymer P2 is selected from a polymer having a higher peel strength to the surface to be coated relative to polyurethane. In exemplary embodiments, polymer P2 has a peel strength of more than 5 N/25 mm, or more preferably more than 10 N/25 mm, or in some examples more than 20 N/25 mm or 25 N/25 mm, so that when blended with polyurethane, the coating achieves a peel strength greater than polyurethane alone, of between about 1 N/25 mm to 20 N/25 mm, or in some cases between 1 to 10 N/25 mm. In some embodiments where the peel strength of the coating to the surface is sufficiently low, the act of peeling the coating can be carried out by hand manually. In other embodiments where the adhesion bond strength of the coating to the surface is high, peeling may be carried out with the aid of tools, or by incorporating peel tabs at various parts of the coating. In an exemplary embodiment, the peel strength (ASTM D1000) of the coating to the surface is about 10 N/25 mm or preferably about 5 N/25 mm. Referring to various technical literature, various 3M Scotch Weld polyurethane reactive adhesives or structural adhesives exhibit peel strengths commonly above 250-300 N/25 mm by comparison.

In order to achieve a flexible coating, polymer P2 has, in addition to the properties of higher peel strength, a higher percent elongation at break in comparison to polyurethane. Depending on the specific formulation, various polyurethane coatings may show elongation at break values of less than 25%, or less than 50%, or less than 100%. Hence, the elongation at break characteristic of polymer P2 is not fixed, but relative to the polyurethane present. In exemplary embodiments, polymer P2 has a percent elongation at break of more than 200%, or more preferably more than 500% elongation at break.

In some embodiments, P2 is selected from polyesters, polyurethane-acrylates (PUA), polyacrylates, polyvinyl alcohol, polyvinyl acetate, acrylate modified polyolefins, and a combination thereof. Polymer P2 may also be selected from soft or elastomeric thermoplastic polyurethanes having soft segment domains having polyol/polyether/polyester linkages, blended with the major component of polyurethane with hard segment domains having urethane linkages. Generally, polymer P2 may be selected from polymers compatible with polyurethane, i.e., capable of homogeneous blending with polyurethane. Polyurethane and polymer P2 may both comprise a water dispersible polymer. Optionally, the film formation characteristics of polymer P2 may be considered. In other embodiments, P2 comprises a pressure sensitive adhesive (PSA) polymer. Examples of suitable PSA polymers include PSAs that contain elastomers such as acrylics, ethylene vinyl acetate, vinyl ethers and styrene block copolymers.

By blending polyurethane with polymer P2 having the aforementioned properties, coatings formed becomes both peelable and flexible. In this manner, the coating may be formed as a single layer adhering directly to the surface to be coated, as no surface primer or intermediate adhesive layer or tackifier is required. The single layer coating may be formed through the application of one coat, or through the application of multiple coats. One coat may be suitable for forming a thin layer, whereas multiple coats of 2, 3, 4, or more coats successively may be suitable for forming a thick layer. In this regard, the coating thickness may range from a thin layer of 100 microns, or 10 microns, or less, to a thick layer of 1000 microns, or 10000 microns, or more. In some embodiments for floor coatings, the typical thickness of a coating ranges from 100 microns to 200 microns.

In one embodiment, the coating is formed from a plasticizer-free coating formulation. By being plasticizer-free, it is meant that the coating is at least substantially, or totally, free of conventional plasticizers used to increase the plasticity or fluidity of the coating composition. In the case of polyurethanes, phthalate-based plasticizers such as di-isooctyl phthalate (DIOP) or other phthalate esters have been commonly used plasticizers. The absence of such compounds renders the coating composition plasticizer free. Phthalate-free formulations are desirable because of the documented harmful effects of phthalates on the human body. The presence of minute or trace quantities of such plasticizers, such as a content of less than 0.1% by weight, or more preferably less than 0.01% by weight, may inadvertently be present and may be considered essentially plasticizer free.

In some embodiments, the coating further comprises a third polymer P3 having higher peel strength to the surface to be coated and/or higher percent elongation at break than polymer P2 when cured. Polymer P3 is provided as an adhesion and modulus modifier to complement P2, compensating for weaker properties in P2. The addition of a third polymer P3 may be used to achieve coating properties that are unachievable through the combination of polyurethane and polymer P2 alone. P3 may be selected from a polymer that on its own forms a very soft & flexible film when cured.

In some embodiments, the coating may comprise three different polymers, namely, polyurethane, a second polymer P2 and a third polymer P3. In one example, polymer P2 has higher peel strength than polyurethane but percent elongation at break that is similar or marginally higher than polyurethane, and polymer P3 has higher percent elongation at break than P2, hence compensating for the low flexibility of P2. In another example, polymer P2 has higher percent elongation at break than polyurethane but similar or marginally better adhesion to a specified substrate, and a third polymer P3 which provides better adhesion to the substrate than P2, hence compensating for the low peel strength of P2. Hence, polymer P3 may be selected to compensate for poor peel strength and/or poor flexibility of polymer P2. Depending on the properties of P2 that require compensating, P3 may be selected from polymers that exhibit greater than 700%, or 1000% elongation at break, and high peel strength of greater than 25 N/25 mm, or greater than 30 N/25 mm.

P3 may also be selected from polymers having other properties such as chemical resistance and thermal resistance or to modify the minimum film formation temperature (MFFT) the glass transition temperature of the polymer blend. In one embodiment, P3 comprises a polymer having MFFT of about 0° C. or less, and a glass transition temperature substantially similar to the minimum film formation temperature. This enables film formation at room temperature. In one example, P3 comprises a polymer having a combination of MFFT of less than 0° C. and 1000% elongation at break to facilitate film formation without co-solvent added and to impart flexible properties to the cured coating.

In embodiments of coatings comprising polyurethane and polymer P2, the following illustrative compositional ranges may be used: the coating may comprise 60% to 90% by weight of polyurethane and 10% to 40% by weight of polymer P2 (dry solid content). In an exemplary embodiment, polymer P2 comprises polyacrylate present in an amount such that the weight ratio of polyurethane to polyacrylate in the coating is between 1 to 10. In another exemplary embodiment, polymer P2 comprises polyurethane with soft segment domains having polyol/polyether/polyester linkages, blended with polyurethane with hard segment domains having urethane linkages. In accordance with the foregoing, the coating may comprise any of the following compositional combinations: (i) 60% polyurethane+40% polyurethane-acrylates, (ii) 70% polyurethane+30% polyacrylates, (iii) 80% polyurethane+20% polyurethane, (iv) 90% polyurethane+10% polyvinylalcohol. Other possible combinations include the following: (i) 70% polyurethane comprising hard segment domains having urethane linkages covalently coupled to 30% polyurethane comprising soft segment domains having polyol/polyether/polyester linkages, (ii) 70% polyurethane+30% polyacrylate, (iii) 70% polyurethane+30% polyurethane-acrylate, (iv) 60% polyurethane+20% polyurethane+20% polyurethane-acrylate, (v) 70% polyurethane+30% polyvinyl acetate.

In embodiments comprising polyurethane, polymer P2 and polymer P3, the coating may comprise 60% to 90% by weight of polyurethane, 5% to 30% by weight of polymer P2, and 5% to 30% by weight of polymer P3. For example, the coating may comprise any of the following compositions: (i) 60% polyurethane+30% polyurethane-acrylates+10% polyvinylacetate; (ii) 70% polyurethane+20% polyacrylates+polyesters.

In a preferred embodiment, the coating further comprises particles distributed or dispersed in the polymer blend. The polymer blends of polyurethane and polymer P2, and optionally polymer P3, as described above provide a convenient peelable, flexible matrix for holding various types of particulate materials that serves various functions. Examples of contemplated particulate materials include desiccants, fire retardants, antifouling materials, disinfectants, ultraviolet absorbing materials, heat absorbing materials, photocatalysts, aromatic compounds, insecticides, color pigments, reflective materials and high refractive index materials.

In one embodiment, the particulate materials comprise slip resistant granules (or particles). The addition of slip resistant granules gives rise to slip resistant floor coatings that provide increased traction & slip resistance that the polymeric coating alone may not be able to achieve. Slip resistant granules may comprise an organic selected from the group consisting of polyolefin, polyacrylate, polyester, nylon, polycarbonate, polyoxymethylene, fluoropolymer, styrene, and polyurethane. Slip resistant granules may comprise thermoplastic polyolefins such as polyethylene (PE), polypropylene (PP), polymethylpentene (PMP), polybutene-1 (PB-1); as well as polyolefin elastomers such as polyisobutylene (PIB), Ethylene propylene rubber (EPR), ethylene propylene diene monomer (M-class) rubber (EPDM rubber).

In a preferred embodiment, slip resistant granules comprise Polypropylene (PP) granules. PP granules can be purchased inexpensively. They were found to provide good compositional stability due to its density and non-polar nature. When cured, polypropylene granules were found to provide high slip resistance, as well as similar refractive index to the polyurethane of about 1.4 to 1.5, which can help maintain the high gloss on the coating surface. Its low density of 0.8 g/cc at 25° C., can improve the storage stability of the final coating product without precipitation. Also, the blocky shape of polypropylene granules helps to prevent injury in the event of fall/slip accident. In exemplary embodiments, the coating may be formed using a coating composition comprising between 1% to 10% by weight of polypropylene granules, or preferably between 1% to 5% by weight of polypropylene granules.

Slip resistant granules may also comprise inorganic materials selected from the group consisting of calcium carbonate, talc, barytes, clays, silicas, titanium dioxide, carbon black, organo-clay, alumina, and carbon nanotubes, glass bubbles, silicon carbide, quartz, cerium oxide, silica, ceramic particles, and ground minerals. Other types of materials such as ionomers, rubber particles, core-shell particles, or engineering plastic polymers with high temperature resistance such as polyether ether ketone (PEEK) and polyethersulfone (PES) may be used to achieve slip resistance.

The slip resistant granules may have a size of between 10 to 1000 microns, or in exemplary embodiments, between 30 to 400 microns. A combination of large particles and small particles, as illustrated in the figures, may also be used. In some embodiments, the particles are selected to be of a size that is less than the thickness of the coating to be applied. Where high slip resistance is required, large particles that exceed coating thickness may be selected in order for the particles to protrude from the coating, thereby providing greater surface contact for increasing contact friction. Beyond a certain size threshold, the particles may cause the coating to lose its glossy appearance due to the lower light scattering ability of the larger particles. Hence, an optimal range exists where an acceptable balance between slip resistance and glossiness may be achieved, if glossiness is a consideration. In one embodiment, this optimal range occurs with formulations that comprises particles with a size of between about 60 to 200 microns. Such a formulation can exhibit slip resistance of at least 20 BNP, or at least 25 or more preferably at least 30 BNP, as tested by the British Pendulum Slip Resistance Tester under wet conditions, and gloss of at least 20 GU, or at least 30 GU, or at least 40 GU, or more preferably at least 50 GU at 60° as measured by a standard glossmeter (ISO 2813).

In some cases, pre-existing finish coatings on the surface to be coated may interfere with the adhesion between the peelable coating and the surface. Specifically, peelability issues may arise due to the different adhesion levels between the coating and the surface, leading to excessively high or low levels of adhesion between the coating and the surface. For example, floor substrates may have been coated with various floor finish coating products comprising polymeric materials such as acrylic polymers or polyurethane coating resins for floor protection. These various floor finish coatings can increase or decrease the peel strength of the peelable coating to be applied, hence affecting the peelable performance of the coating to be applied. In order to keep the peelable performance consistent regardless of pre-existing floor finish present, a primer coating layer may be added as an intermediate layer between the peelable coating to be applied and the pre-existing floor finish, i.e., in this embodiment, the coating further comprises a primer layer arranged between the coating and the surface. The primer layer provides a predictable interface for the peelable coating, so that consistent peelability or peel strength is achieved regardless of the floor finish coating present. Hence, in this context, the term “primer” as referenced in the term “primer coating layer”, herein also used interchangeably with the term “primer layer”, denotes a material that primes the surface to be coated by modifying, either by increasing or decreasing, the adhesion of the coating to the surface to a level that is suitable for the desired peelable performance.

In one embodiment, the primer layer comprises a release coating for decreasing the adhesion of the coating to the surface. The release coating may comprise surface active agents, such as polymers that have low surface energy, as exemplified by acrylic polymers and polyurethane polymers that are silicone or fluorine modified, or fluoropolymers which are synthesized from fluorinated monomers that have a certain degree of substitution of carbon chain hydrogen by fluorine. Polymer coatings that exhibit relatively low surface energy, such as paraffin, polypropylene, polyethylene and polytetrafluoroethylene (PTFE), may also be suitable as release coatings. Certain commercially available floor finishes may also be suitable for use as release coatings, such as 3M Scotchgard™ Vinyl Floor Protector, and other floor finishes exhibiting low surface energy, such as silane or fluoro containing compounds and polymers. In preferred embodiments, the primer comprises at least one of a fluorinated compound, fluoropolymer or fluorine modified polymer, an acrylic polymer, a polyurethane, a polyurethane acrylate, a silicone compound, a silicone modified polymer, paraffin wax, polypropylene wax, polyethylene wax, and mixtures thereof.

The adhesion peel strength of the peelable coating to the floor surface may also be tuned to a desired range by incorporating surface active materials, particularly low surface energy additives, directly into the coating, without using a primer layer, or optionally, in combination with a primer layer as described in the foregoing paragraphs. For example, low surface energy polymers similar to those used for the primer layer may be added as an adhesion modifying additive to the peelable coating, or alternatively to the floor finish. Other examples of suitable low surface energy materials include polymeric fluorochemical surfactants such as 3M Novec™ fluorosurfactants, silicone polyethers available from Dow Corning Inc., low tack adhesives such as styrene/acrylic acid copolymer microspheres, and hexafluoropropylene oxide (HFPO).

In another embodiment, the primer layer comprises an adhesion promoter for increasing the adhesion of the coating to the floor surface. This may be useful in cases where the surface to be coated contains low surface energy materials, such as polypropylene, polyethylene, polytetrafluoroethylene (PTFE), or have resins/oil/wax from the floor timber accumulating on the surface over time, for example. In other examples, the primer layer is an interface or intermediate layer serving other functions than adhesion modification, such as a primer layer functioning as a protective layer (e.g., a polycarbonate primer layer), or as a backing to enable the peelable layer to be cohesively detached from a substrate surface, or a coloring layer, for example.

Base additives may be present in the coatings to achieve the necessary physical or chemical properties required in a specific application. As described below, base additives may be added to the liquid coating composition before application to the surface to be coated. The additives may comprise volatile compounds that vaporize away during the curing of the coating, or it may comprise non-volatile compounds that stay in the coating after curing. Where polymer P2 is selected to form a partially immiscible blend with polyurethane, polar or partially polar organic co-solvents may be added to enable miscibility between the polymers present. Rheology modifiers may be added to control the viscosity of the composition. For example, a specific application may require the composition to be sufficiently viscous to appropriately suspend slip resistant particles in the composition. Thus, the viscosity of the composition should facilitate uniformly loading the particles on an applicator prior to actual application. It may also be important that the viscosity of the composition be such that the composition does not excessively flow when being applied but permits an applicator to control the final thickness of the resulting floor coating. Further examples of base additives include defoamers, leveling agents, and organic wax emulsions. To provide the coatings with additional functionalities, additives such as biocides, pigments, fillers, colorants, dyes, anti-cratering agents and anti-sagging agents may also be added to the coating.

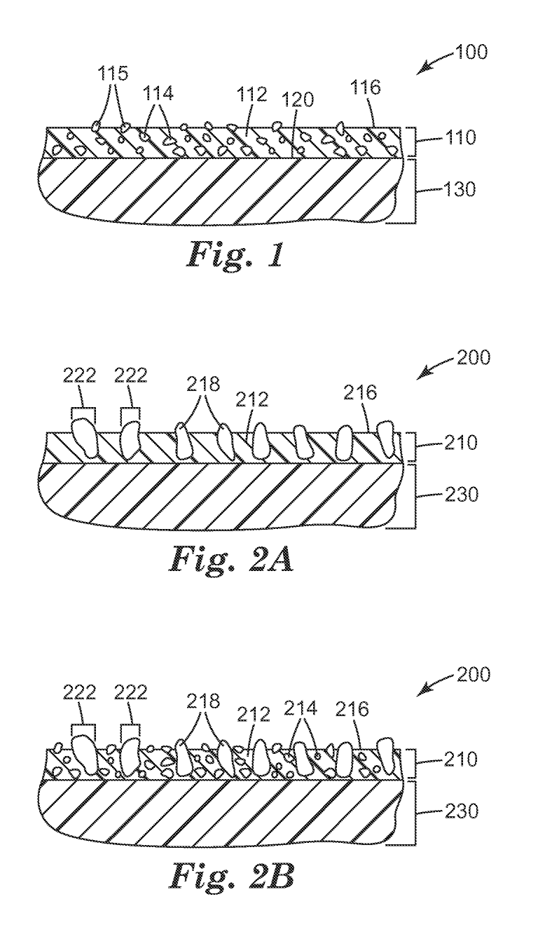

Referring to FIG. 1, there is shown a cross section of a coated surface 100. Coating 110 is formed directly on the surface 120 of an item 130 to be coated. Coating 110 comprises a cured polymer matrix 112, made up of a blend of polyurethane and polymer P2, and optionally other components such as polymer P3 and base additives, and slip resistant particles 114 dispersed throughout the matrix 112. The particles 114 have a diameter that is smaller than the thickness of the coating 110, hence they remain largely embedded within the coating 110. Some surface particles 115 may randomly be present at the surface 116. The proportion of surface particles 115 may increase with the use of larger quantities of particles 114, resulting in an increase in the coefficient of friction of surface 116 of the coating 110, as compared to the coefficient of friction of surface 116 comprising purely of cured polymer matrix 112 or with smaller quantities of particles 114.

Referring to FIG. 2A, a coated surface 200 is shown comprising coating 210 formed directly on an item 230 to be coated. Coating 210 comprises a cured polymeric matrix 212 and slip resistant particles 218 present throughout the matrix 112. The particles 218 have a diameter that is equal to or exceeds the thickness of the coating 210, so particles 218 protrude above the coating surface 216. The protruding portions 222 of particles 218 may help to significantly increase the overall coefficient of friction of surface 216 of the coating 210. As all particles 218 provide a protruding portion 222, the coefficient of friction increases with the amount of particles 218 added to the coating 210. In FIG. 2B, coating 210 comprises a cured polymeric matrix 212 and particles 214, 218 of two different sizes present throughout the matrix 112. Particles 218 may comprise slip resistant granules whereas particles 214 may comprise reflective materials for increasing the glossiness of the coating. The particles 214 have a diameter that is smaller than the thickness of the coating, so particles 214 remain largely embedded within the coating 210, while the particles 218 have a diameter that is equal to or exceeds the thickness of the coating 210, so particles 218 protrude above the coating surface 216 to increase the overall coefficient of friction of surface 216 of the coating 210.

In another aspect, a coating composition is provided for forming a peelable flexible coating for a surface as described in the foregoing paragraphs, comprising an aqueous blend of a first polymer dispersion D1 comprising polyurethane as a major component, and a second polymer dispersion D2 comprising a polymer P2 having a higher peel strength to the surface to be coated and higher percent elongation at break when cured in comparison polyurethane.

The term ‘dispersion’ in this context conforms to the definition in the IUPAC Compendium of Chemical Terminology (2007), which defines a dispersion to be a material comprising more than one phase, where at least one of the phases consists of finely divided phase domains, often in the colloidal size range, distributed throughout a continuous phase domain. The first polymer dispersion D1 may comprise a water-based polyurethane dispersion (PUD), such as commercially available polyurethane dispersions from Dow (e.g., SYNTEGRA® polyurethane dispersions) or from Bayer (e.g., Bayhydrol® aqueous polyurethane dispersions, or Dispercoll® aqueous polyurethane dispersions), for example. The second polymer dispersion D2 comprising polymer P2 may comprise a water-based polymer dispersion compatible for blending with D1. Commercially available dispersions for polyesters, polyurethane-acrylates (PUA), polyacrylates, polyvinyl alcohol, polyvinyl acetate, acrylate modified polyolefins may be identified by various trade names, such as BASF (e.g., Acronal® aqueous polyacrylate dispersions) or Bayer (e.g., Bayhaydrol A® aqueous polyacrylate dispersions) or DSM (e.g., NeoCryl® acrylic copolymer dispersions or NeoPac® polyurethane-acrylate dispersions) or Bayer (e.g., Bayhdrol® E aqueous polyester dispersions) or Achema (e.g., PVAD® polyvinyl acetate dispersions) or Nuplex (e.g., Acropol® polyvinyl acetate dispersions). A third polymer dispersion D3 comprising polymer P3, as described in the foregoing paragraphs, may also be present if it is desired to include polymer P3 into the coating. D3 may comprise a water-based polymer dispersion compatible for blending with D1 and D2.

The coating composition may comprise total solid polymer content of between 20% to 60% by weight of the composition. In typical embodiments, the solid content is about 30% to 45%. The ratio of polyurethane to polymer P2 may vary between 80% to 90% by weight of polyurethane and 10% to 20% by weight of polymer P2. Where polymer P3 is present in the coating composition, the ratio of polyurethane to polymer P2 and P3 may vary between 80% to 90% by weight of polyurethane, 5% to 10% by weight of polymer P2, and 5% to 10% by weight of polymer P3, for example.

Polar organic co-solvents may be used in the coating composition to bring polyurethane and polymer P2, and optionally polymer P3 into a common phase. Examples of such co-solvents include butoxydiglycol, butyl glycol, glycol ethyl ether, DEG ethyl ether, alkylene glycol ethers such as ethylene glycol monomethyl ether, ethylene glycol monohexyl ether, ethylene glycol monoethyl ether, ethylene glycol mono-n-butyl ether, diethylene glycol monomethyl ether, diethylene glycol mono-n-butyl ether, propylene glycol monomethyl ether, dipropylene glycol monomethyl ether, tripropylene glycol monomethyl ether, ethylene glycol monoisobutyl ether, diethylene glycol monoisobutyl ether, propylene glycol monoisobutyl ether, ethylene glycol monophenyl ether, propylene glycol monophenyl ether, ethylene glycol monomethyl ether acetate, and mixtures thereof.

In a further aspect, a method is provided to form the coating composition, comprising the steps of: providing a first polymer dispersion D1 comprising polyurethane, providing a second polymer dispersion D2 comprising a polymer P2 having in comparison to polyurethane a higher peel strength to the surface to be coated and a higher percent elongation at break than polyurethane when cured, and blending D1 and D2 at standard ambient temperature and pressure. Quantities of D1 and D2 are provided such that polyurethane is a major component and P2 is a modifier for imparting a flexible and peelable quality to the coating.

The blend of D1 and D2 may be further blended with particulate materials, such as slip resistant granules. It may also be mixed with various base additives such as polar or partially polar organic co-solvents, rheology modifiers, defoamers, leveling agents, and organic wax emulsions, biocides, anti-sagging agent, anti-cratering agent, color dyes, and combinations thereof. Where it is desired to introduce a third polymer P3 as an adhesion and modulus modifier into the coating composition, the blend of D1 and D2 may be further mixed with a third polymer dispersion D3 comprising a polymer P3. Polymer P3 may have higher peel strength to the surface to be coated and/or higher percent elongation at break when cured than polymer P2, for example.

In one embodiment, the step of mixing particulate materials to the composition may be carried out as a last step, after the blending of polymer dispersions D1, D2 is carried out. To achieve a good distribution of the particles within the polymer blend, stirring is carried out until an even distribution of particles is achieved. This may be carried out under moderate stirring of 300 to 500 rpm for 5 minutes or more, for example.

In a yet further aspect, a method of forming a peelable protective coating on a surface is also provided. The method comprises the steps of providing a coating composition as described above, and applying the coating composition to the surface with an applicator, and curing the coating composition at standard ambient temperature and pressure. The applicator may comprise a brush, a roller or a steel spreader, optionally with the aid of a squeegee.

In some embodiments, between 0.05 to 1 liter of coating composition is applied per square meter of surface to be coated, depending on the thickness of the coating to be applied. The volume of coating composition may be applied over a single coat, or over several consecutive coats. Curing the coat is necessary to allow volatile solvents to vaporize, thereby enabling the polymers present in the composition to phase change into a hardened state. In some embodiments, the glass transition temperature (‘T_{g}’) of the polymer blend in the coating composition is above or well above room temperature. In some exemplary embodiments, if P2 and/or P3 comprise rubbery elastomers, the T_{g} may be below room temperature so the coating is relatively soft and flexible. Drying of the coating at standard ambient temperature and pressure (IUPAC) may be carried out for 0.5 to 1 hour.

### Example 1

### Preparation of Polyurethane-Polyacrylic Blended Dispersion with PP Granules

Synthesis. Various polyurethane and polyurethane-acrylate dispersions known by trade names Bayhydrol UH 2593/1, Bayer Material Science and NeoRez R-2180, DSM NeoResins and Bayhydrol UH 240, Bayer Material Science and Bayhydrol, and NeoPac E-122, DSM NeoResins, and Bayhydrol A 2651, Bayer Material Science were mixed by 5 minute-mild stirring at room temperature. Secondly, a small amount of co-solvents such as butoxydiglycol, butyl glycol, glycol ethyl ether and diethylene glycol ethyl ether, was added slowly into the mixture of polymer dispersions with stirring at 300 rpm for 5 minutes. Then, some additives such as defoamers, leveling agents, and organic wax emulsion, in addition, a thickener that is based on polyurethane, were incorporated into the mixture with the mild agitation. Lastly, micron-sized polypropylene granules were added. The agitation speed was 300 to 500 rpm for 5 minutes to form a homogeneously blended coating composition.

Prior to coating operation, the floor surface was cleaned to remove the dust and stain on the floor. The amount of coating composition generally depends on the thickness of coated film required on the floor. To achieve a 0.15 mm coating thickness over a tile area of 667 mm² or roughly 26 mm by 26 mm, 0.1 Liters of coating binder was used. For coating, the coating composition is poured onto the floor tile and coated uniformly with a brush and/or roller. The floor surface was allowed to dry through ambient air drying at room temperature for 0.5 to 1 hours. The drying time may take longer, depending on the thickness of coated film.

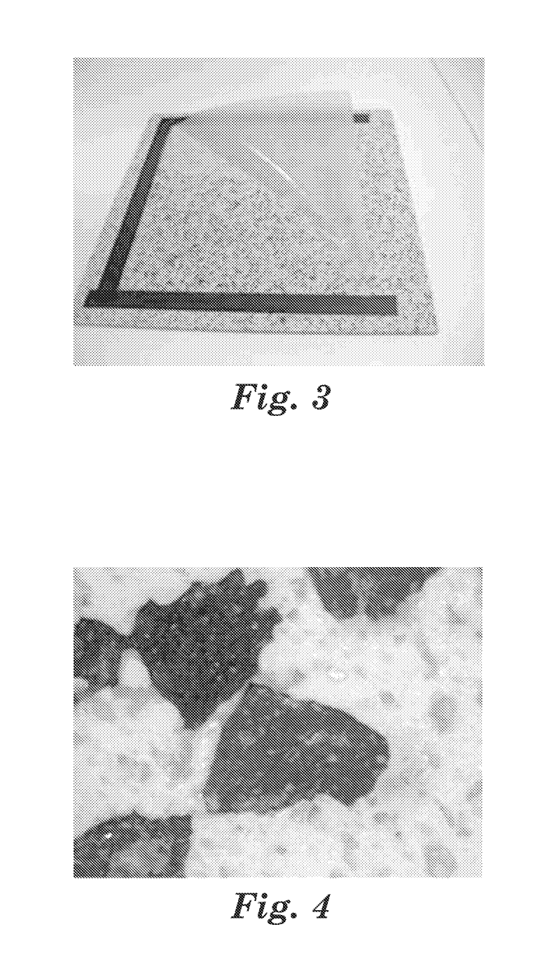

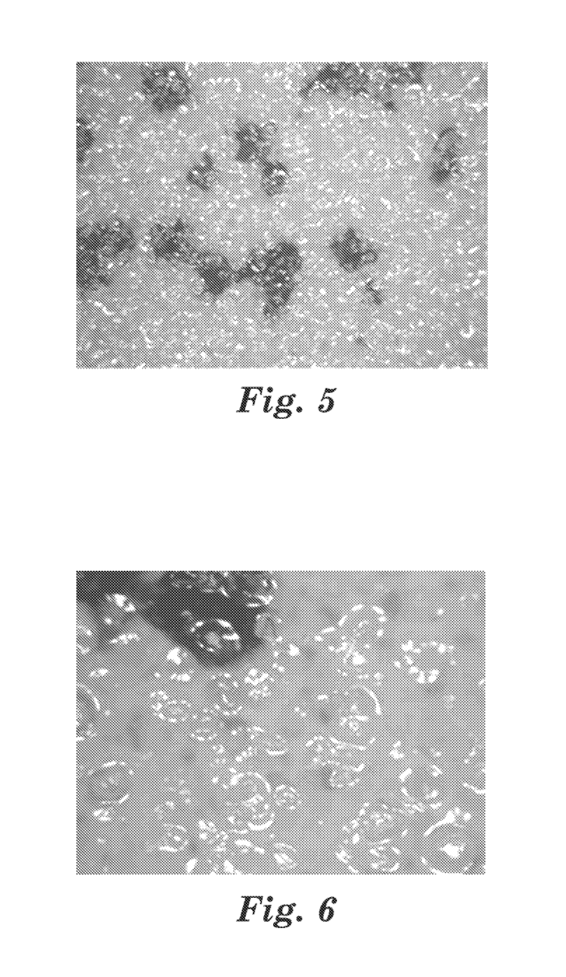

FIG. 3 shows a photograph of a coating that has been partially peeled from a floor surface. Due to the improved flexibility of the coating, it bends flexibly without cracking. FIG. 4 is an optically magnified image taken of an uncoated vinyl tile surface used in this example. FIG. 5 and FIG. 6 show images of the same vinyl tile coated with micron-sized organic polypropylene particles.

Performance Evaluation.

To determine the slip resistance, gloss and peel-off properties of the coated surface, different particle sizes were used in the coating to evaluate the correlation with particle size versus slip resistance, gloss and peel-off properties. Slip resistance was measured by British Pendulum Slip Resistance Tester under wet condition. Gloss was measured by Glossmeter (20° and 60°) from Munro Instruments Ltd. The ability to remove the surface film was tested manually for peel strength with an Intron tester and tear properties of the coated film was visually evaluated during the peeling operation.

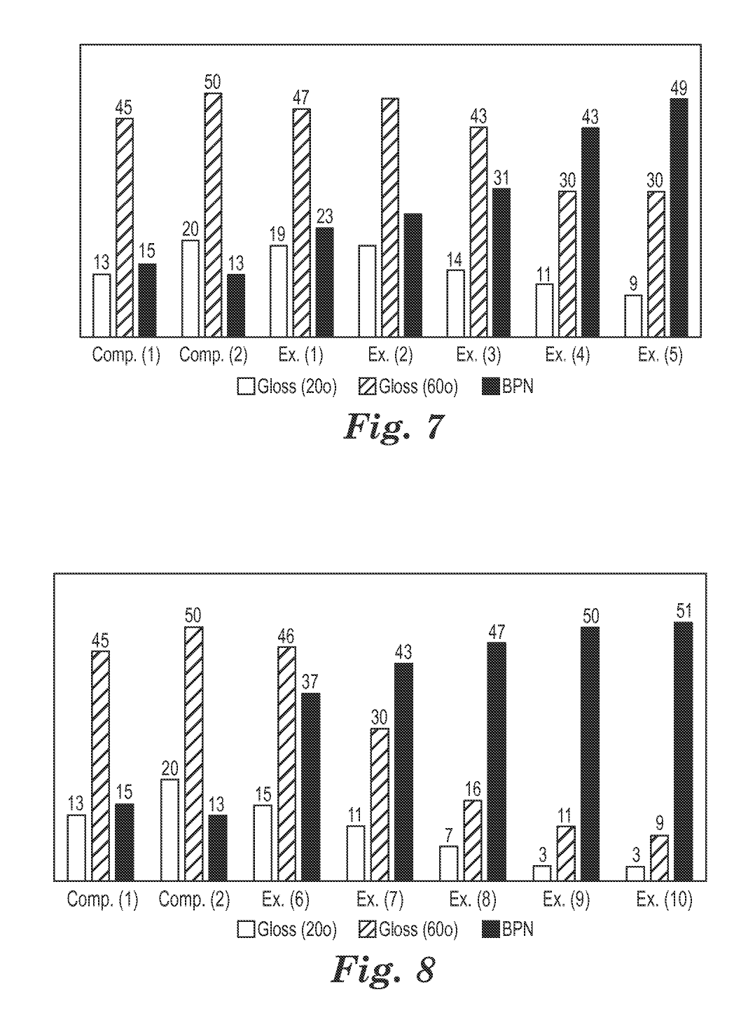

Table 1 below shows a table of results obtained from coatings with different particle sizes. Comparative examples were provided using 3M Scotchgard Stone Protector™ without particles (Comparative Example 1), a coating composition obtained from polyurethane and polyacrylate without adding particles (Comparative Examples 2), and a coating composition obtained from polyurethane and polyacrylate with various size of polypropylene particles (Examples 1 to 5). FIG. 7 shows a bar chart comparing the gloss values and slip resistance (numerals above bars) of each example. It can be seen that increasing particle size provided increasing slip resistance. Coatings without particles had poorer slip resistance. However, gloss was generally lower with the inclusion of particles into the coating. 30 to 60 micron-sized particles did not greatly affect the gloss of the coated floor surface, and was able to achieve improve slip resistance. Although 90 to 400 micron-sized particles reduced the gloss of the coated floor surface, slip resistance was doubled or trebled in BPN value. The 60° gloss value of 30 (in Example 4 & 5) belongs to a good range of the gloss in the floor coating market. Also, slip resistance value of 35 BPN provides very high slip resistance properties under wet condition. Moreover, all experiments show the easy peel-off properties of the coatings in Examples 1 to 5.

TABLE 1
Table of test results obtained from coatings with different particle sizes

| | Polypropylene | | Slip | | | |
|---|---|---|---|---|---|---|
| | Particle Size | % | Resistance | Gloss | Peel- | Tear of |
| Example | (micron) | Content | (BPN) | (20°/60°) | off | film |
| Comparative 1 | No particles | 0 | 15 | 13/45 | N/A | N/A |
| Comparative 2 | No particles | 0 | 13 | 22/55 | Easy | No |
| Example 1 | 30 | 2.0 | 23 | 19/47 | Easy | No |
| Example 2 | 60 | 2.0 | 25 | 21/51 | Easy | No |
| Example 3 | 90 | 2.0 | 31 | 14/43 | Easy | No |
| Example 4 | 200 | 2.0 | 43 | 11/30 | Easy | No |
| Example 5 | 400 | 2.0 | 47 | 9/30 | Easy | No |

Table 2 below shows a table of results obtained from different coatings with 200 micron particles with varying particle content. Likewise, comparative examples were provided using 3M Scotchgard Stone Protector™ without particles (Comparative Sample 1), a coating composition obtained from polyurethane and polyacrylate without adding particles (Comparative Sample 2), and a coating composition obtained from polyurethane and polyacrylate with varying polypropylene particle content ranging from 1% to 5% by weight (Samples 1 to 5). FIG. 8 shows a bar chart comparing the gloss values and slip resistance (numerals above bars) of each Example. Slip resistance appeared to be correlated to content of particles up to about 4% by weight since formulation with particle content greater than 4% did not return higher BPN values. Conversely, gloss showed the inverse correlation with particle content, with gloss values decreasing with increasing particle content. Consequently formulations with 1% or 2% by weight of particle content provided acceptably high slip resistance (more than 35 BPN) and acceptable gloss (more than 30 at 60° gloss). Regarding peel-off properties, coatings in Sample 1 to 4 resulted in coatings with acceptable peel. Sample 5 with 5% of particle content was difficult to peel due to tearing during removal. Generally it was found that increasing particle content led to harder and stiffer films.

TABLE 2
Table of test results obtained from different coatings
with 200 micron particles with varying particle content

| | Polypropylene | | Slip | | | |
|---|---|---|---|---|---|---|
| | Particle Size | % | Resistance | Gloss | Peel- | Tear of |
| Example | (micron) | Content | (BPN) | (20°/60°) | off | film |
| Comparative 1 | No particles | 0 | 15 | 13/45 | N/A | N/A |
| Comparative 2 | No particles | 0 | 13 | 22/55 | Easy | No |
| Example 6 | 200 | 1.0 | 37 | 15/46 | Easy | No |
| Example 7 | 200 | 2.0 | 43 | 11/30 | Easy | No |
| Example 8 | 200 | 3.0 | 47 | 7/16 | Easy | No |
| Example 9 | 200 | 4.0 | 50 | 3/11 | Easy | No |
| Example 10 | 200 | 5.0 | 51 | 3/9 | Not Easy | Partially |
| | | | | | (breakage) | Yes |

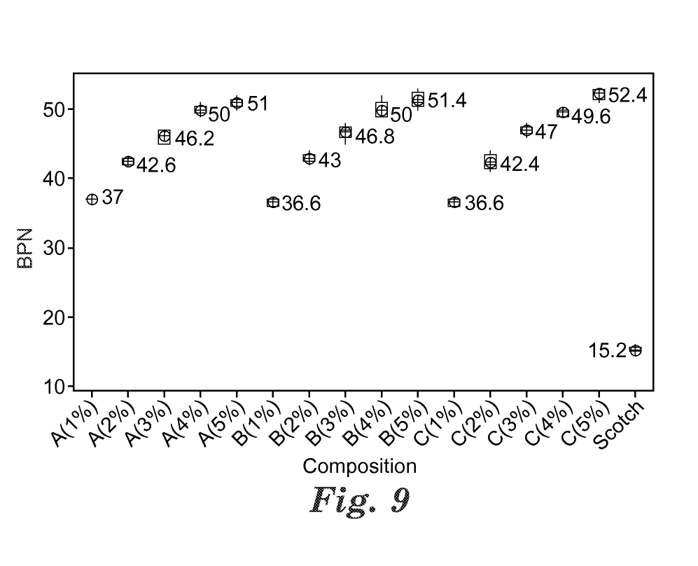

The variation of slip resistance was measured in a series of reproducibility tests (A, B, C) over varying polypropylene particle content ranging from 1% to 5% by weight, using a fixed particle size of 200 microns. Scotchgard Stone Protector™ coating without particles was used as a control. FIG. 9 shows the variation of slip resistance under wet conditions. Slip resistance was consistent throughout the 3 tests, showing that the coating compositions were of uniform consistency throughout the samples that were prepared.

### Example 2

### Preparation of Polyurethane-Polyvinyl Acetate Blended Dispersion with HDPE Granules

Synthesis. Polyurethane dispersion (Bayhydrol UH 2593/1, Bayer Material Science) and polyvinyl acetate dispersion (Acropol 63893, Nuplex Industries Ltd) were mixed by 5 minute-mild stirring at room temperature. Secondly, a small amount of co-solvents such as butoxydiglycol, butyl glycol, glycol ethyl ether and diethylene glycol ethyl ether, was added slowly into the mixture of polymer dispersions with stirring at 300 rpm for 5 minutes. Additives such as defoamers, leveling agents, and organic wax emulsion, in addition, a thickener that is based on polyurethane, were incorporated into the mixture with the mild agitation. Lastly, micron-sized high density polyethylene (HDPE) granules were added. The agitation speed was 300 to 500 rpm for 5 minutes until a homogeneous coating composition was obtained. The coating composition was applied on a floor surface and left to dry. The coating formed was flexible and soft, and had a very smooth and cushioned feel.

### Example 3

### Preparation of Polyurethane-Polyurethane Blended Dispersion with Inorganic Glass Bubble Granules

Synthesis.

A first polyurethane dispersion (Bayhydrol UH 2593/1, Bayer Material Science) and second polyurethane dispersion (NeoRez R-2180, DSM NeoResins) were mixed by 5 minute-mild stirring at room temperature. Secondly, a small amount of co-solvents such as butoxydiglycol, butyl glycol, glycol ethyl ether and diethylene glycol ethyl ether, was added slowly into the mixture of polymer dispersions with stirring at 300 rpm for 5 minutes. Then, some additives such as defoamers, leveling agents, and organic wax emulsion, in addition, a thickener that is based on polyurethane, were incorporated into the mixture with the mild agitation. Lastly, micron-sized inorganic glass bubble granules (Glass Bubble K 46, 3M) were added. The agitation speed was 300 to 500 rpm for 5 minutes until a homogeneous coating composition was obtained. The coating composition was applied on a floor surface and left to dry. The coating formed displayed film hardness, and was not transparent, but some hazy (a mild white) colored film.

### Example 4

### Preparation of Polyurethane-(Polyacrylate) blended dispersion with (inorganic glass beads

Synthesis. Polyurethane dispersions (Bayhydrol UH 240, Bayer Material Science) and polyacrylate dispersion (Bayhydrol A 2651, Bayer Material Science) were mixed by 5 minute-mild stirring at room temperature. Secondly, a small amount of co-solvents such as butoxydiglycol, butyl glycol, glycol ethyl ether and diethylene glycol ethyl ether, was added slowly into the mixture of polymer dispersions with stirring at 300 rpm for 5 minutes. Then, some additives such as defoamers, leveling agents, and organic wax emulsion, in addition, a thickener that is based on polyurethane, were incorporated into the mixture with the mild agitation. Lastly, micron-sized inorganic glass beads (Glass bead W-210, 3M) were added. The agitation speed was 300 to 500 rpm for 5 minutes until a homogeneous coating composition was obtained. The coating composition was applied on a floor surface and left to dry. Similar to Example 3, the coating formed displayed film hardness, and was not transparent, but some hazy (a mild white) colored film.

### Example 5

### Preparation of Polyurethane-Polyacrylate Blended Dispersion with Inorganic Silica Beads

Synthesis.

Polyurethane dispersions (Bayhydrol UH 240, Bayer Material Science) and polyacrylate dispersion (Bayhydrol A 2651, Bayer Material Science) were mixed by 5 minute-mild stirring at room temperature. Secondly, a small amount of co-solvents such as butoxydiglycol, butyl glycol, glycol ethyl ether and diethylene glycol ethyl ether, was added slowly into the mixture of polymer dispersions with stirring at 300 rpm for 5 minutes. Then, some additives such as defoamers, leveling agents, and organic wax emulsion, in addition, a thickener that is based on polyurethane, were incorporated into the mixture with the mild agitation. Lastly, micron-sized inorganic silica beads (Aerosil R 8125, Evonik Industries) were added. The agitation speed was 300 to 500 rpm for 5 minutes until a homogeneous coating composition was obtained. The coating composition was applied on a floor surface and left to dry. Similar to Example 3 and 4, the coating formed displayed film hardness, and was not transparent, but some hazy (a mild white) colored film.

Coatings described herein are suitable for use on any surface where protection, cleanliness, gloss, scuff resistance, and/or slip resistance is desirable. Such surfaces include floors, food preparation surfaces, walls, stalls, counters, bathroom fixtures, etc. The surfaces to be finished may be made from a large variety of materials including, but not limited to, acrylic tiles, ceramic tiles, marble, stone, metal and wooden laminate, terrazzo, ceramic, linoleum, plastics, rubber, concrete, vinyl composition tiles (“VCT”) and glass.

Although the present invention has been described with particular reference to preferred embodiments illustrated herein, it will be understood by those skilled in the art that variations and modifications thereof can be effected and will fall within the scope of this invention as defined by the claims thereto now set forth herein below.

1. A peelable, flexible coating for a surface, comprising:
a polymer blend that comprises polyurethane as a major component, and at least a polymer P2 having in comparison to polyurethane a higher peel strength to the surface to be coated and a higher percent elongation at break when cured for imparting a flexible and a peelable quality to the coating.

2. The coating of claim 1, wherein the coating is formed as a single layer directly on the surface to be coated, without a tackifier layer.

3. The coating of claim 1, wherein the peel strength (ASTM D1000) of the coating to the surface to be coated is between 1 N/25 mm to 10 N/25 mm.

4. The coating of claim 1, wherein the percent elongation at break of polymer P2 is more than 500% and the peel strength of polymer P2 to the surface to be coated is more than 20 N/25 mm.

5. The coating of claim 1, wherein the coating comprises 60% to 90% by weight of polyurethane and 10% to 40% by weight of polymer P2.

6. The coating of claim 1, further comprising a polymer P3 having higher peel strength to the surface to be coated and/or higher percent elongation at break when cured than polymer P2.

7. The coating of claim 6, wherein the coating comprises 60% to 90% by weight of polyurethane, 5% to 30% by weight of polymer P2, and 5% to 30% by weight of polymer P3.

8. The coating of claim 1, wherein polymer P2 is selected from the group consisting of:
polyesters, polyurethane-acrylates (PUA), polyacrylates, polyvinyl alcohol, polyvinyl acetate, acrylate modified polyolefins, soft segment domain polyurethanes, and a combination thereof.

9. The coating of claim 8, wherein polymer P2 comprises polyacrylate present in an amount such that the weight ratio of polyurethane to polyacrylate in the coating is between 1 to 10.

10. The coating of claim 1, further comprising particles distributed in the polymer blend.

11. The coating of claim 10, wherein the particles comprise slip resistant granules.

12. The coating of claim 11, wherein the slip resistant granules comprise an organic polymer selected from the group consisting of polyolefins, polyacrylates, polyesters, nylon, polycarbonates, polyoxymethylenes, fluoropolymers, styrene, and polyurethanes.

13. The coating of claim 11, wherein the slip resistant granules have a size of between 10 to 1000 microns.

14. The coating of claim 11, wherein the coating comprises between 1% to 10% by weight of slip resistant granules.

15. The coating of claim 14, wherein the slip resistant granules comprise an inorganic material selected from the group consisting of:
calcium carbonate, talc, barytes, clays, silicas, titanium dioxide, carbon black, organo-clay, alumina, carbon nanotubes, glass, silicon carbide, quartz, cerium oxide, silica and ceramic particles.

16. The coating of claim 1, wherein the particles comprise one of the following materials: desiccants, fire retardants, antifouling materials, disinfectants, ultraviolet absorbing materials, heat absorbing materials, photocatalysts, aromatic compounds, insecticides, desiccants, color pigments, reflective materials and high refractive index materials.

17. The coating of claim 1, further comprising a primer layer arranged between said coating and the surface.

18. (canceled)

19. (canceled)

20. (canceled)

21. (canceled)

22. (canceled)

23. A coating composition for forming a peelable, flexible coating on a surface, comprising:
an aqueous blend of a first polymer dispersion D1 that comprises polyurethane as a major component, and a second polymer dispersion D2 comprising a polymer P2, polymer P2 having in comparison to polyurethane a higher peel strength to the surface to be coated and a higher percent elongation at break when cured.

24. The composition of claim 23, wherein the composition is free of any plasticizer compound.

25. A method of forming a peelable, flexible coating on a surface, comprising the steps of:
providing a coating composition that comprises an aqueous blend of a first polymer dispersion D1 comprising polyurethane as a major component, and a second polymer dispersion D2 comprising a polymer P2 having in comparison to polyurethane a higher peel strength to the surface to be coated and a higher percent elongation at break when cured, and
applying the coating composition over the surface, and
curing the coating composition at ambient conditions.

26. (canceled)
